(19) United States
(12) Patent Application Publication
(10) Pub. No.: US 2026/0228951 A1
(43) Pub. Date: Aug. 6, 2026

(54) KVP-SWITCHING SPARSE-VIEW CT IMAGES RESTORATION WITH AN EDGE PRIOR MAP

(71) Applicants: THE REGENTS OF THE UNIVERSITY OF CALIFORNIA, Oakland, CA (US); CANON MEDICAL SYSTEMS CORPORATION, Tochigi (JP)

(72) Inventors: Jinyi QI, Oakland, CA (US); Nimu YUAN, Oakland, CA (US); Jian ZHOU, Vernon Hills, IL (US)

(73) Assignees: THE REGENTS OF THE UNIVERSITY OF CALIFORNIA, Oakland, CA (US); CANON MEDICAL SYSTEMS CORPORATION, Tochigi (JP)

(21) Appl. No.: 19/451,459

(22) Filed: Jan. 16, 2026

Related U.S. Application Data
(60) Provisional application No. 63/754,433, filed on Feb. 5, 2025.

(51) Int. Cl. G06T 12/20; G06T 11/10

(52) U.S. Cl. CPC G06T 12/20; G06T 11/10; G06T 2211/408; G06T 2211/441

(57) ABSTRACT

A method for reconstructing computed tomography (CT) images, including receiving dual-energy tomography data acquired by imaging an object using a CT apparatus, the dual-energy tomography data including a first set of tomography data at a first energy level and a second set of tomography data at a second energy level, the second energy level being greater than the first energy level; generating, based on the dual-energy tomography data, a first sparse view projection of the first set of tomography data at the first energy level and a second sparse view projection of the second set of tomography data at the second energy level; generating, based on the dual-energy tomography data, a texture map; and generating a predicted image at the first energy level by applying the first sparse view projection and the generated texture map to a trained machine learning model.

### CROSS-REFERENCE TO RELATED APPLICATIONS

The present application claims priority to U.S. Patent Application No. 63/754,433, which was filed Feb. 5, 2025, and which is incorporated herein by reference in its entirety for all purposes.

### FIELD

The present disclosure is related to computed tomography (CT) imaging systems.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Dual-energy CT data can be acquired by switching between generating X-rays having high- and low-kilo-voltage peaks (kVp). kVp-switching CT systems can have advantages such as enhanced tissue characterization and material differentiation. However, the switching between energy levels leads to sparse-view (SV) CT data at each energy level and can result in streaky artifacts that can degrade fine structural details and compromise the usability of the tomography data for material decomposition.

### SUMMARY

In one embodiment, the present disclosure relates to a method for reconstructing computed tomography (CT) images, comprising receiving dual-energy tomography data acquired by imaging an object using a CT apparatus, the dual-energy tomography data including a first set of tomography data at a first energy level and a second set of tomography data at a second energy level, the second energy level being greater than the first energy level; generating, based on the dual-energy tomography data, a first sparse view projection of the first set of tomography data at the first energy level and a second sparse view projection of the second set of tomography data at the second energy level; generating, based on the dual-energy tomography data, a texture map; and generating a predicted image at the first energy level by applying the first sparse view projection and the generated texture map to a trained machine learning model, wherein the trained machine learning model was previously trained to generate an image using a set of training data comprising a training sparse view projection of single-energy tomography data and a training texture map generated from the single-energy tomography data.

In one embodiment, the present disclosure relates to a computed tomography (CT) apparatus, comprising processing circuitry configured to receive dual-energy tomography data acquired by imaging an object using a CT apparatus, the dual-energy tomography data including a first set of tomography data at a first energy level and a second set of tomography data at a second energy level, the second energy level being greater than the first energy level; generate, based on the dual-energy tomography data, a first sparse view projection of the first set of tomography data at the first energy level and a second sparse view projection of the second set of tomography data at the second energy level; generate, based on the dual-energy tomography data, a texture map; and generate a predicted image at the first energy level by applying the first sparse view projection and the generated texture map to a trained machine learning model, wherein the trained machine learning model was previously trained to generate an image using a set of training data comprising a training sparse view projection of single-energy tomography data and a training texture map generated from the single-energy tomography data.

In one embodiment, the present disclosure relates to a non-transitory computer-readable storage medium for storing computer readable instructions that, when executed by a computer, cause the computer to perform a method, the method comprising receiving dual-energy tomography data acquired by imaging an object using a CT apparatus, the dual-energy tomography data including a first set of tomography data at a first energy level and a second set of tomography data at a second energy level, the second energy level being greater than the first energy level; generating, based on the dual-energy tomography data, a first sparse view projection of the first set of tomography data at the first energy level and a second sparse view projection of the second set of tomography data at the second energy level; generating, based on the dual-energy tomography data, a texture map; and generating a predicted image at the first energy level by applying the first sparse view projection and the generated texture map to a trained machine learning model, wherein the trained machine learning model was previously trained to generate an image using a set of training data comprising a training sparse view projection of single-energy tomography data and a training texture map generated from the single-energy tomography data.

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the disclosure and embodiments, the reader is directed to the Detailed Description section and corresponding figures of the present disclosure as further discussed below.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an image pre-processing workflow, according to one embodiment of the present disclosure;

FIG. 2A is a network training workflow, according to one embodiment of the present disclosure;

FIG. 2B is a network training workflow, according to one embodiment of the present disclosure;

FIG. 3A is a network deployment workflow, according to one embodiment of the present disclosure;

FIG. 3B is a network deployment workflow, according to one embodiment of the present disclosure;

FIG. 4 is an image pre-processing workflow, according to one embodiment of the present disclosure;

FIG. 5A is a network training workflow, according to one embodiment of the present disclosure;

FIG. 5B is a network training workflow, according to one embodiment of the present disclosure;

FIG. 6A is a network training workflow, according to one embodiment of the present disclosure;

FIG. 6B is a network training workflow, according to one embodiment of the present disclosure;

FIG. 7A is a network deployment workflow, according to one embodiment of the present disclosure;

FIG. 7B is a network deployment workflow, according to one embodiment of the present disclosure;

FIG. 8A is a sinogram, according to one embodiment of the present disclosure;

FIG. 8B is a sinogram, according to one embodiment of the present disclosure;

FIG. 8C is a sinogram, according to one embodiment of the present disclosure;

FIG. 9 is an illustration of a network architecture, according to one embodiment of the present disclosure;

FIG. 10A is a linearly interpolated sinogram, according to one embodiment of the present disclosure;

FIG. 10B is a predicted sinogram using an alternative network, according to one embodiment of the present disclosure;

FIG. 10C is a predicted sinogram using the network according to one embodiment of the present disclosure;

FIG. 10D is a full-view reference sinogram, according to one embodiment of the present disclosure;

FIG. 11A is a reconstructed image using sparse view projection, according to one embodiment of the present disclosure;

FIG. 11B is a reconstructed image using linearly interpolated projection, according to one embodiment of the present disclosure;

FIG. 11C is a predicted reconstructed image, according to one embodiment of the present disclosure;

FIG. 11D is a predicted reconstructed image, according to one embodiment of the present disclosure;

FIG. 11E is a reconstructed image using full-view projection, according to one embodiment of the present disclosure;

FIG. 12 is a quality assessment of a reconstructed image, according to one embodiment of the present disclosure;

FIG. 13A is a reconstructed image from sparse-view projections, according to one embodiment of the present disclosure;

FIG. 13B is a reconstructed image from linearly interpolated sparse view projections, according to one embodiment of the present disclosure;

FIG. 13C is a reconstructed image from predicted projections without using a texture map, according to one embodiment of the present disclosure;

FIG. 13D is a reconstructed image from predicted projections using a texture map, according to one embodiment of the present disclosure;

FIG. 13E is a reference reconstructed image from full-view projection, according to one embodiment of the present disclosure;

FIG. 14A is a reconstructed image from sparse-view projections, according to one embodiment of the present disclosure;

FIG. 14B is a reconstructed image from linearly interpolated sparse-view projections, according to one embodiment of the present disclosure;

FIG. 14C is a reconstructed image from predicted projections without using a texture map, according to one embodiment of the present disclosure;

FIG. 14D is a reconstructed image from predicted projections using a texture map, according to one embodiment of the present disclosure;

FIG. 14E is a reference reconstructed image from full-view projection, according to one embodiment of the present disclosure;

FIG. 15 is a method of predicting a sinogram, according to one embodiment of the present disclosure, and

FIG. 16 is a schematic block diagram of a CT apparatus or scanner, according to embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, configurations, etc., herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

In one embodiment, the present disclosure is directed to reconstruction of dual-energy computed tomography (CT) data using machine-learning models. Generative deep learning-based models can be used to enhance images such as sinograms, e.g. by reducing noise and similar artifacts in an acquired image or filling in missing data (such as a sparse-view CT sinogram) in order to generate a restored image that is of higher quality than the acquired image. A sinogram can be a visualization of the projection data acquired at different X-ray angles and detector positions. Enhancing a sinogram can result in an enhanced CT image when the sinogram is used for reconstruction.

Training models to enhance dual-energy CT sinograms or images typically requires paired full-view CT scans that are acquired at both the high- and low-kVp energies. However, this scan data is rare and/or difficult to acquire, especially in volumes that are sufficient for model training. Traditional approaches to training a model using single-energy CT data results in a faulty model that has limited ability to restore details when applied to dual-energy CT data. Therefore, there is a need for a more efficient method of training a generative model to make use of single-energy CT data to accurately enhance dual-energy CT images.

In one embodiment, the generative model can be a denoising diffusion probabilistic model (DDPM). It can be appreciated that DDPMs are described herein as an illustrative example of a class of generative models, and that other types of machine learning models and especially diffusion-based probabilistic models for image restoration are also compatible with the methods of the present disclosure.

A DDPM can be used to denoise an image in a series of diffusion steps. The DDPM can be trained to denoise an image in an iterative process, wherein the DDPM generates an increasingly denoised image at each diffusion step. The DDPM can be trained to denoise an image by converting a first probability distribution corresponding to an input image (e.g., a noisy input image) to a predicted second probability distribution corresponding to an output image (e.g., a denoised image). In one example, the first probability distribution can be a normal distribution corresponding to normal (Gaussian) noise that is present in an input image. The DDPM can be trained to remove the noise by converting the normal probability distribution to a predicted distribution corresponding to a denoised, restored image.

In one embodiment, a DDPM can be trained using a set or sequence of training images. The set of training images can include input images and target images, wherein the target images are clean or denoised images corresponding to the input images. In one embodiment, the input images can be conditional images. Each denoising step of the DDPM can be conditioned on (or guided by) one or more conditional images. The DDPM can be trained to denoise a noisy image using the one or more conditional images to output a restored image at each step in a series of diffusion steps. In this manner, the DDPM can be trained to “reverse” a stepwise process for applying noise to an image in order to remove said noise from the image.

In one embodiment, the training images can be generated using single-kVp CT sinograms rather than dual-kVp CT sinograms. The DDPM can be trained to denoise dual-kVp CT sinograms even though the training images do not include actual data acquired at both kVp levels. In one embodiment, the model can be trained and deployed using reconstructed images (image domain) or sinograms (sinogram domain).

In one embodiment, the training images can include texture maps (edge maps) as conditional images. Texture maps capture high-frequency structural details without artifacts and can effectively guide the network to reduce noise and restore fine structures in the final reconstructed images.

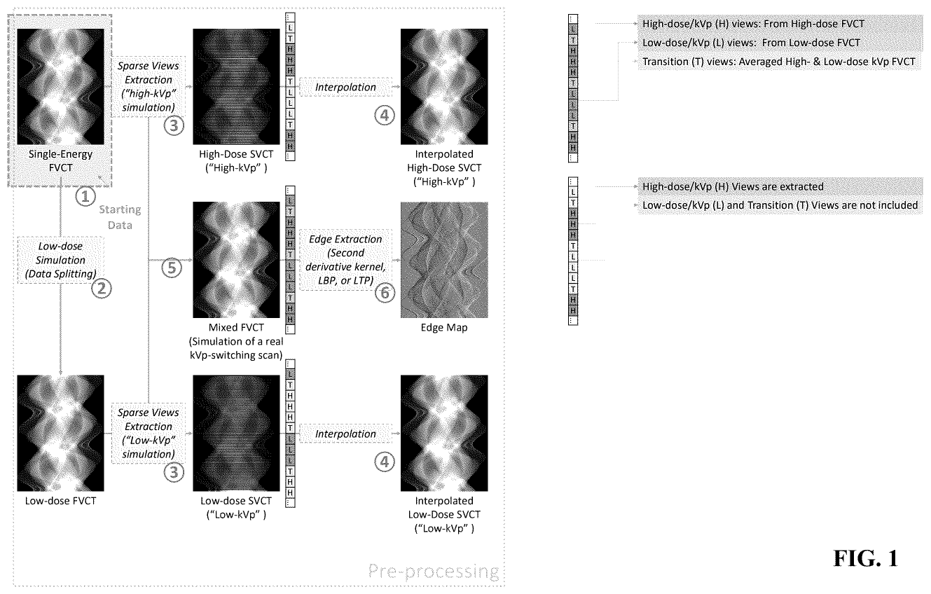

FIG. 1 is an illustration of a pre-processing workflow for generating training images according to one embodiment. In one embodiment, training images can be generated from a single-energy sinogram. As an example, the single-energy sinogram can be acquired at 120 kVp rather than a high (e.g., 135 kVp) or low (e.g., 80 kVp) energy that may be used for dual-energy acquisition. In one embodiment, the single-energy sinogram can be a full-view sinogram, as illustrated in FIG. 1. In one embodiment, the single-energy sinogram can be used to generate a simulated low-kVp full-view sinogram in order to train the model to process dual-energy data. In one embodiment, the low-energy simulation can include simulating a different dose level in order to capture the higher noise in low-kVp sinograms due to reduced beam penetration. In one embodiment, sinograms at different dose levels can be generated using a count-domain dose splitting method to mimic the noise characteristics of different kVp CT projections. Additional detail can be found in N. Yuan, J. Zhou, and J. Qi, “Half2 Half: deep neural network based CT image denoising without independent reference data,” Phys. Med. & Biol., vol. 65, no. 21, p. 215020, 2020, which is incorporated herein by reference in its entirety. These sinograms having different dose levels can be randomly combined to simulate a dual-energy switching scan (mixed kVp sinogram).

In one embodiment, the simulated low-kVp full-view sinogram and the single-energy full-view sinogram can be sampled to generate sparse view sinograms (SVCTs) at the respective energies. FIG. 1 illustrates that the sparse high-kVp sinogram and the sparse low-kVp sinogram each have less data than the full-view sinogram to mimic the switching in a single acquisition. In one embodiment, the sparse high-kVp sinogram and the sparse low-kVp sinogram can be combined to generate a mixed full-view sinogram (FVCT), which represents a simulation of a real kVp-switching scan that combines sinogram data at both energies. In one embodiment, the mixed sinogram can be generated using a pattern of pixels from the sparse CTs. An example of the pattern is illustrated in the single-column kernel of FIG. 1, which includes alternating pixels from the sparse sinograms. In one embodiment, the kernel can follow a 3-1-3-1 pattern to simulate a real kVp-switching scan with transition projections (T) between the high/low projections. In one embodiment, the transition projections can be functions (e.g. an average) of the low-kVp and high-kVp values at the corresponding pixels in each sparse sinogram. In one embodiment, the transition view data can be set to zero.

In one embodiment, the mixed sinogram can then be used to generate an edge map. The edge map can be extracted from the mixed sinogram to capture the features that are consistent across different energy levels. In one embodiment, the edge map can be extracted using a second derivative kernel, a local binary pattern, a local ternary pattern, or other edge/texture detection method. In one embodiment, a one-dimensional local binary pattern can be applied to the values of the mixed sinogram by dividing each one-dimensional sinogram signal into overlapping neighborhoods (cells). In one embodiment, the cell size can be 3 pixels. The intensity of each center pixel in a cell can be compared to its left and right neighbors. A binary number can be assigned to the center pixel based on its comparison. In one embodiment, if the left neighbor has a greater intensity than the center pixel, the center pixel can be assigned a 2 (binary 10). If the right neighbor has a greater intensity than the center pixel, the center pixel can be assigned a 1 (binary 01). The resulting binary numbers from the two comparisons are then summed up to determine a two-bit binary number (0 to 3 in base 10). The sum assigned to the center pixel can be its intensity value in the edge map. For edge pixels, a single comparison with an adjacent neighbor can be performed.

In one embodiment, the sparse high-kVp sinogram and the sparse low-kVp sinogram can each be interpolated to generate an interpolated high-kVp sinogram and interpolated low-kVp sinogram, respectively. The interpolated sinograms at each kVp level can be used as additional input to aid the training of the DDPM. In one embodiment, each sinogram is interpolated using pixels corresponding to its own energy level rather than mixing pixels.

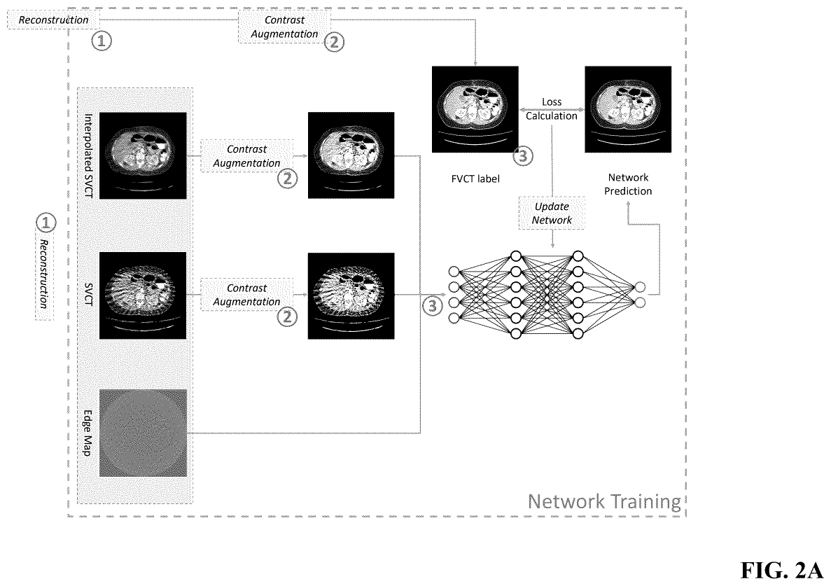

FIG. 2A is an illustration of a network training workflow using high-kVp reconstructed images according to one embodiment of the present disclosure. Images can be reconstructed from the sinograms using filtered back projection or other reconstruction techniques. The network (e.g., a DDPM) can be trained using both high-kVp training data and low-kVp training data that are generated from the single-energy FVCT. Each of the sparse view sinograms can be used to reconstruct a CT image, resulting in a sparse high-kVp reconstructed image and a sparse low-kVp reconstructed image. Each of the interpolated sinograms can be used to reconstruct a CT image, resulting in an interpolated high-kVp reconstructed image and an interpolated low-kVp reconstructed image. The original single-energy sinogram can also be used to reconstruct a single-energy CT image that can be used as a target image during training. In one embodiment, the reconstructed images can be used for separate training steps corresponding to different energy levels. For example, FIG. 2A illustrates first the sparse high-kVp reconstructed image, the interpolated high-kVp reconstructed image, and a reconstruction of the edge map being input to the network as conditional images for training. In one embodiment, prior to being input to the network for training, the reconstructed images can be modified using contrast augmentation. The contrast augmentation can include changing the contrast of the reconstructed images at different training iterations. For example, the contrast can be augmented such that

$${X}_{C A} ( i , j ) = \{ \begin{matrix}{( X ( i , j ) + a )}^{b} , & if ( X ( i , j ) + a ) > 0 \\ - {\vert X ( i , j ) + a \vert}^{c} , & if ( X ( i , j ) + a ) < 0\end{matrix}$$

Wherein X is the original CT Hounsfield Unit (HU) intensity and XCA is the transformed intensity, a is uniformly sampled between −60 and 120, b is uniformly sampled between 1.00 and 1.12, and c is uniformly sampled between 1.00 and 1.04. The contrast augmentation simulates variations in contrast across kVp levels, which improves the robustness of the model to energy-dependent intensity changes in dual-energy CT data and different image qualities. The target image (training label) for the set of training data can be the reconstructed full-view CT image. In one embodiment, contrast augmentation can also be applied to the reconstructed full-view CT image prior to use as the target image.

FIG. 2B illustrates a training workflow using low-kVp reconstructed images according to one embodiment. The sparse low-kVp reconstructed image, the interpolated low-kVp reconstructed image, and the reconstructed edge map can be input to the network as conditional images for training. The edge map can be the same for both the high- and low-kVp training steps because the features captured in the edge map are the same across the energy levels. In one embodiment, contrast augmentation can be applied to the reconstructed images for the workflow of FIG. 2B in the same manner as in FIG. 2A.

At each diffusion step, the DDPM can be trained to minimize a loss function, the loss function corresponding to a difference in noise between a predicted output image and a target image for the given diffusion step. In one embodiment, the loss function L can be defined as L=E_{Y}_{₀}_{,n,k} [∥n-n_{θ}(k, Yₖ, Y_{SVCT}, Yᵢₙₜₑᵣₚ, Yₜₑₓₜᵤᵣₑ)∥] wherein n is the added noise; k is the timestep in the diffusion process; Yₖ is the noise-added image at timestep k; and n_{θ}(k, Yₖ, Y_{SVCT}, Yᵢₙₜₑᵣₚ, Yₜₑₓₜᵤᵣₑ) is the network's predicted noise estimate based on the sparse reconstructed image Y_{SVCT}, the interpolated reconstructed image Yᵢₙₜₑᵣₚ, and the reconstructed edge map Yₜₑₓₜᵤᵣₑ. The loss function can also be used when training the model in the sinogram domain. In one embodiment, the training of the DDPM can include setting one or more weights of the model. The one or more weights of the model can vary for each diffusion step within the series of diffusion steps or for at least one of the diffusion steps within the series.

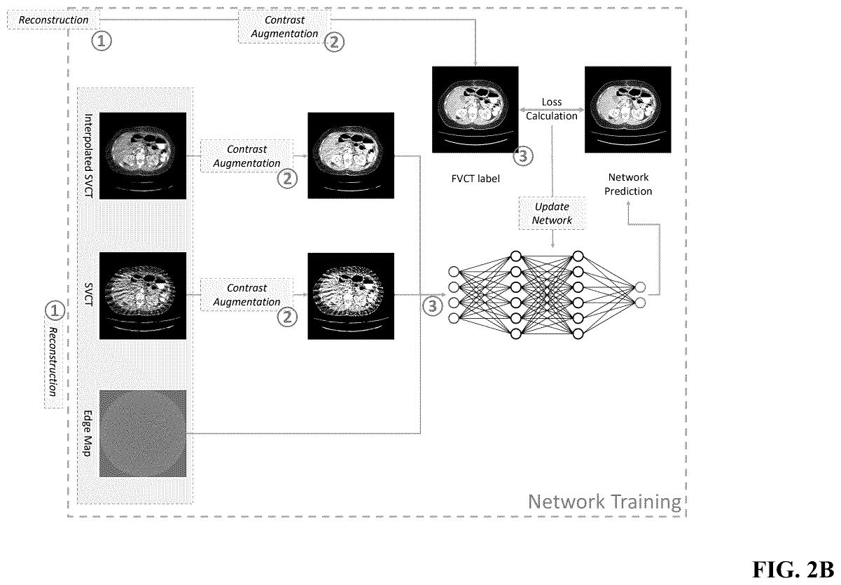

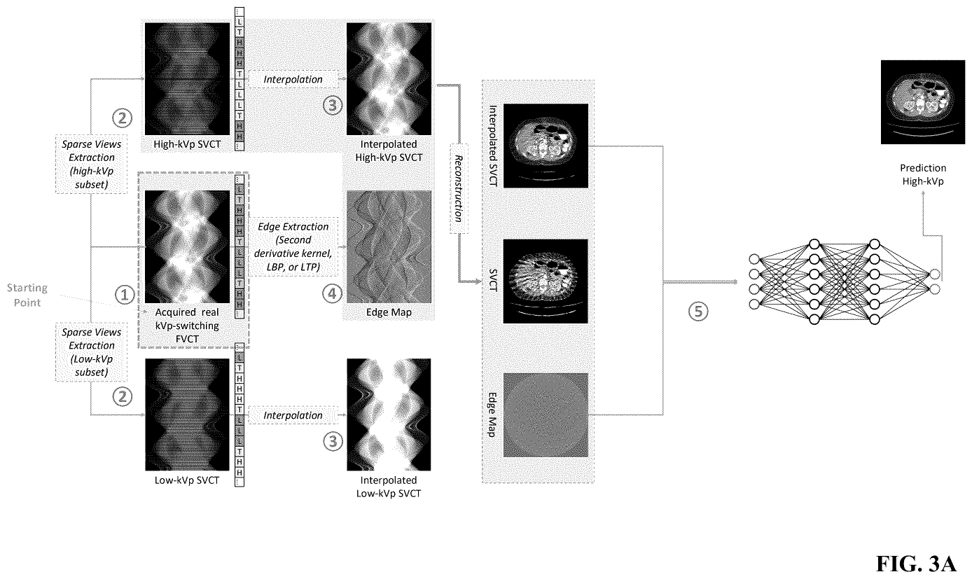

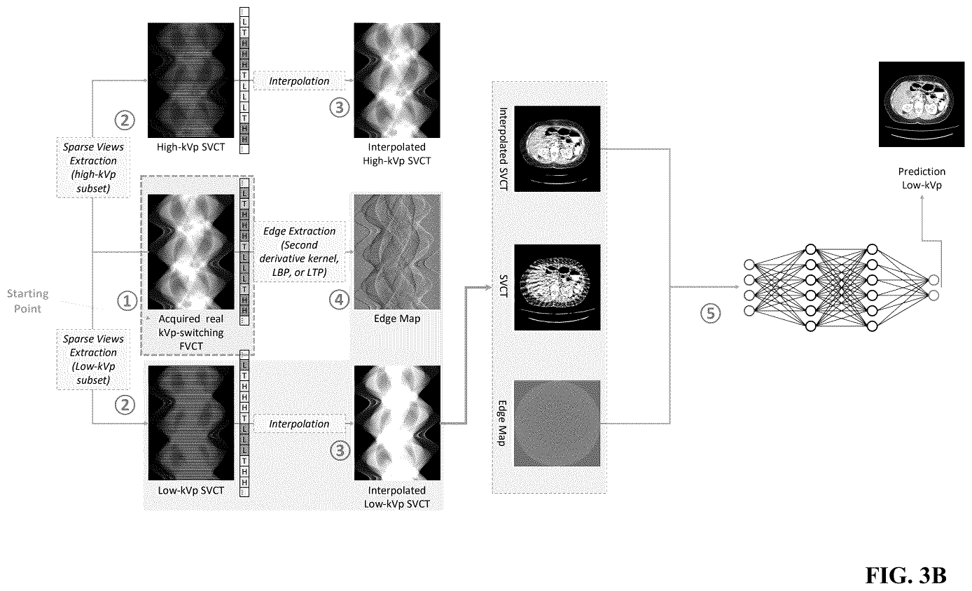

FIG. 3A is an illustration of deployment of a trained network in the image domain to generate a predicted high-kVp image from a dual-kVp CT sinogram according to one embodiment. The trained network can generate predicted low-kVp and high-kVp reconstructed images from an acquired dual-energy sinogram from a real kVp-switching protocol.

Initially, the acquired dual-energy sinogram can be pre-processed before being input to the trained network. In one embodiment, the pre-processing can include separating (extracting) the high-kVp sinogram data and the low-kVp sinogram data from the dual-energy sinogram. The resulting high-kVp SVCT and low-kVp SVCT can be sparse-view sinograms. In one embodiment, the high- and low-kVp sinogram data can be extracted based on a pattern of high (H), low (L), and transition (T) pixels according to the dual-energy acquisition protocol as illustrated in FIG. 3A. The sparse high-kVp sinogram and the sparse low-kVp sinogram can be interpolated to fill in the missing data points after extraction. An interpolated high-kVp reconstructed image can be reconstructed from the interpolated high-kVp SVCT, and an interpolated low-kVp reconstructed image can be reconstructed from the interpolated low-kVp SVCT. A sparse high-kVp reconstructed image can also be reconstructed from the sparse (pre-interpolation) high-kVp sinogram, and a sparse low-kVp reconstructed image can also be reconstructed from the sparse (pre-interpolation) low-kVp sinogram. The pre-processing can include generating an edge map based on the acquired dual-energy sinogram. In one embodiment, the method for generating the edge map (e.g. via second derivative kernel, local binary pattern, local ternary pattern, etc.) can match the method used during network training.

In one embodiment, the trained network can be used to predict a high-kVp image as illustrated in FIG. 3A. The conditional inputs to the trained network can be the sparse high-kVp reconstructed image, the interpolated high-kVp reconstructed image, and the edge map. The predicted high-kVp image can be of higher quality than the input images that are reconstructed from the sparse or interpolated high-kVp sinograms.

FIG. 3B is an illustration of deployment of the trained network in the image domain to generate a predicted low-kVp image from a dual-kVp CT sinogram according to one embodiment. The sparse low-kVp reconstructed image, the interpolated low-kVp reconstructed image, and the edge map can be conditional inputs to the trained network. The trained network can predict a low-kVp image based on the input images. The predicted low-kVp image can be of higher quality than the input images that are reconstructed from the sparse or interpolated low-kVp sinograms. In this manner, the same trained model can be used to generate (predict) both high- and low-kVp images based on a single dual-energy FVCT. The model, which was trained on single-energy CT data, can be used for accurate reconstruction for both high- and low-kVp images from dual-energy CT data.

In one embodiment, a generative model (e.g. a DDPM) can be trained to predict sinograms rather than reconstructed images. The training and deployment of the model for sinogram prediction can be similar to the processes in the image domain described with reference to FIGS. 1, 2A, 2B, 3A, 3B.

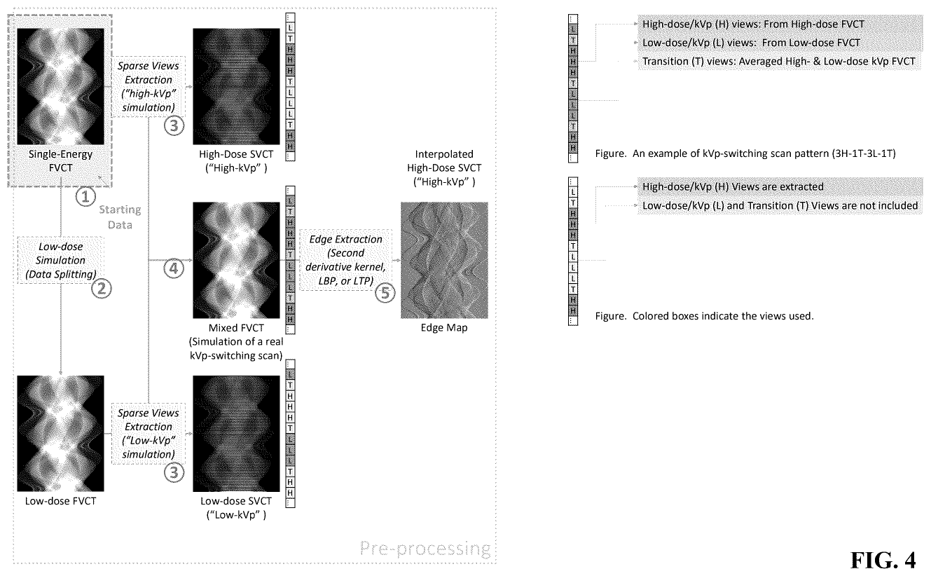

FIG. 4 is an illustration of a pre-processing workflow for generating training sinograms according to one embodiment. The pre-processing for the sinogram domain can be similar to the workflow illustrated in FIG. 1. A single-energy full-view sinogram can be acquired. The single-energy full-view sinogram can be split to generate a simulated low-kVp full-view sinogram. The single-energy full-view sinogram and the simulated low-kVp full-view sinogram can each be sampled to generate sparse view sinograms (SVCTs) at the respective energies. The sparse view sinograms can then be combined to generate a mixed full-view sinogram (FVCT) based on a pixel pattern as illustrated in FIG. 4. In one embodiment, an edge map can be generated from the mixed full-view sinogram. In one embodiment, the sparse high-kVp sinogram and the sparse low-kVp sinogram can each be interpolated to generate interpolated sinograms.

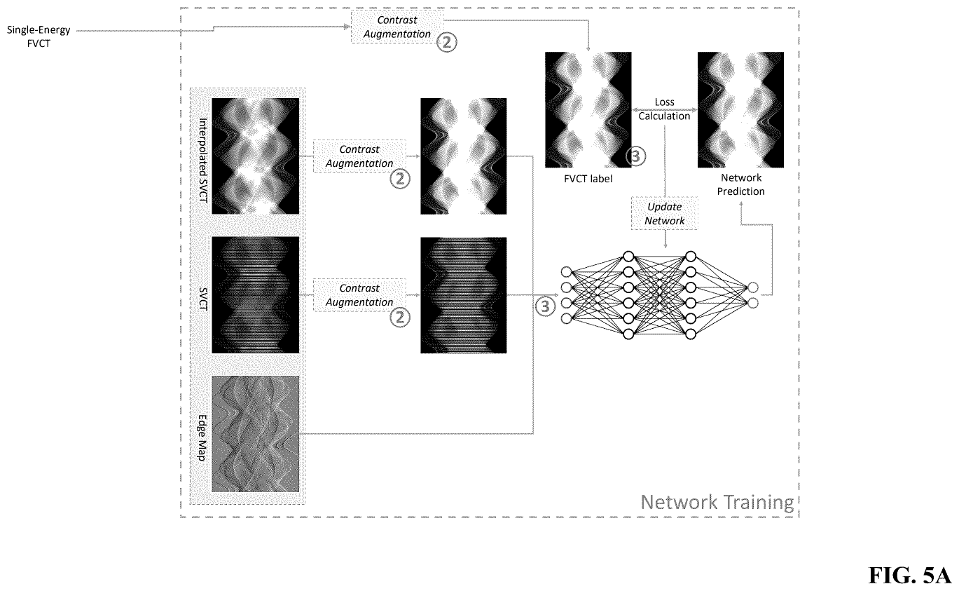

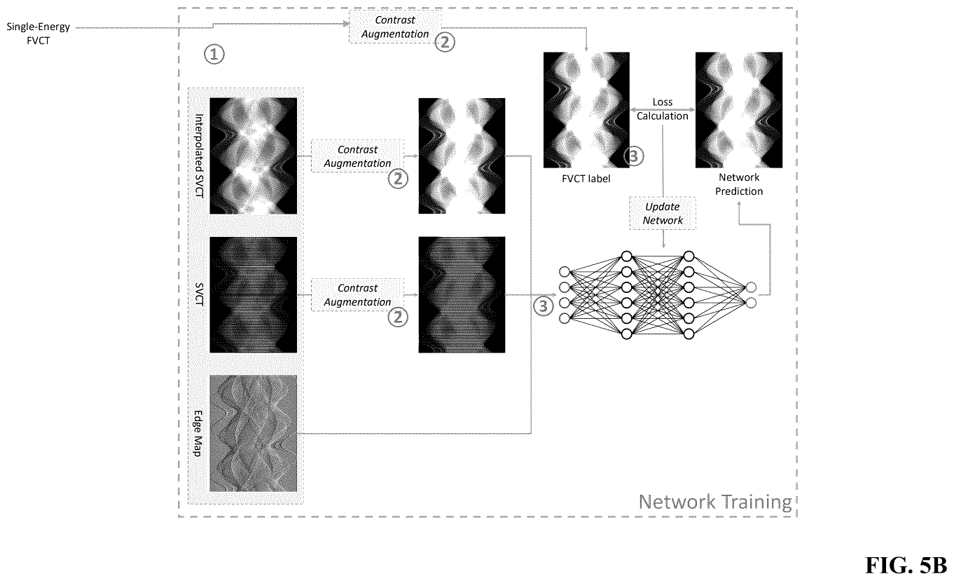

FIG. 5A is an illustration of a network training workflow using high-kVp sinograms according to one embodiment of the present disclosure. The network can be trained using both high-kVp training data (sinograms) and low-kVp training data (sinograms) that are generated from the single-energy sinogram. The high- and low-kVp sinograms can be input to the model separately as training data. For example, FIG. 5A illustrates that the sparse high-kVp sinogram, the interpolated high-kVp sinogram, and the edge map can be input to the model as a first set of training data. In one embodiment, contrast augmentation can be applied to the sinograms before they are input to the model. In one embodiment, contrast augmentation can be modeled as y_{CA}=α×e^{by}−α where y is the original post-log sinogram intensity and y_{CA} is the transformed intensity. In one embodiment, a can be uniformly sampled between 33.0 and 43.0 and b can be uniformly sampled between 0.025 and 0.030. The augmentation can modify positive pixels while preserving background regions. In one embodiment, the contrast augmentation can be applied with 80% probability.

The model can be trained to predict a high-kVp sinogram using the sparse and interpolated high-kVp sinograms and edge map as conditional images. In one embodiment, the model can be trained to minimize a loss function describing an error between a predicted sinogram and a target sinogram as described herein. The target sinogram (training label) can be the original single-energy FVCT.

FIG. 5B is an illustration of a network training workflow using low-kVp sinograms according to one embodiment of the present disclosure. The sparse low-kVp sinogram, the interpolated low-kVp sinogram, and the edge map can be input to the model as another set of training data. In one embodiment, contrast augmentation can be applied to the sinograms before they are input to the model. The model can be trained to predict a low-kVp sinogram using the sparse and interpolated low-kVp sinograms and edge map as conditional images. In one embodiment, the model can be trained to minimize a loss function describing an error between a predicted sinogram and a target sinogram as described herein. The target sinogram (training label) can be the original single-energy sinogram.

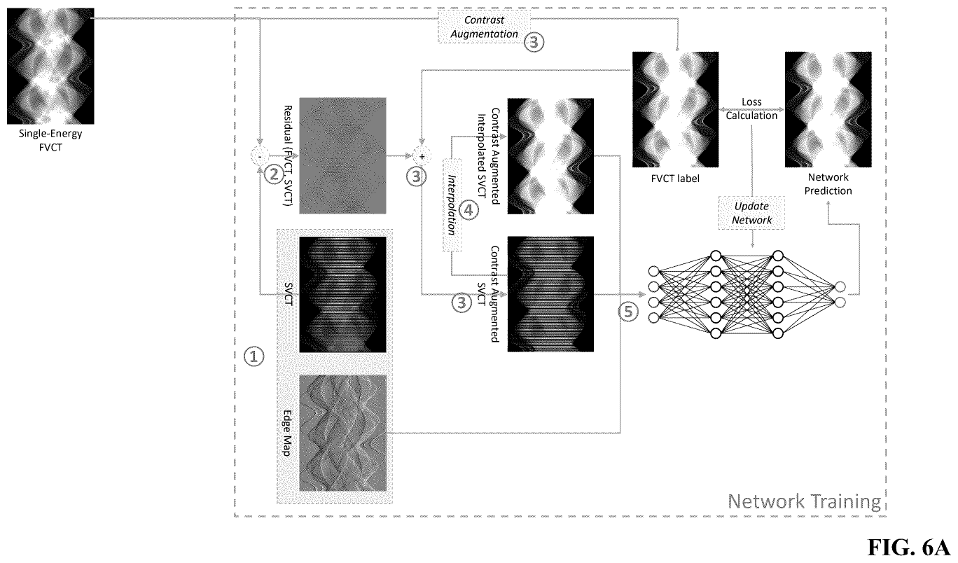

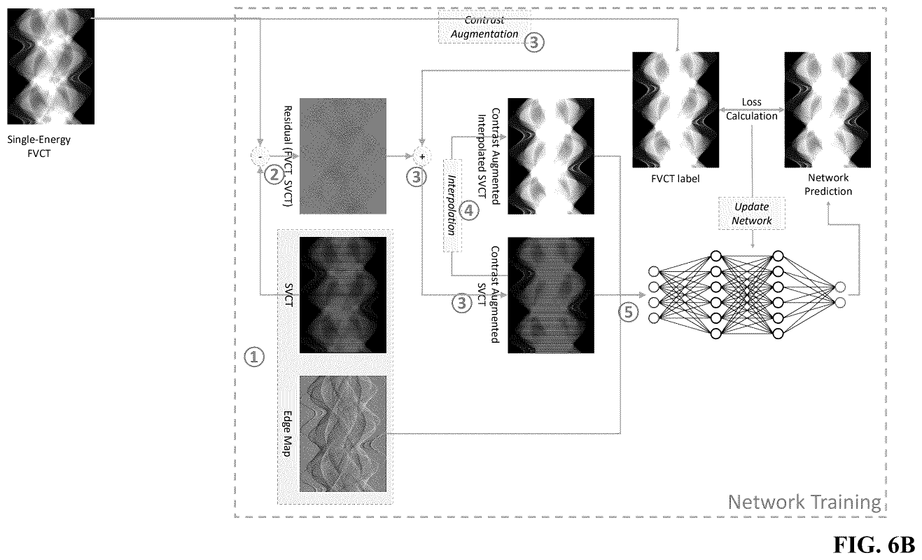

FIG. 6A is an illustration of a network training workflow using residuals to augment sinograms according to one embodiment of the present disclosure. A residual high-kVp sinogram can represent the difference between the sparse high-kVp sinogram and the single-energy full-view sinogram. Contrast augmentation can be applied to the single-energy (full-view) sinogram. The residual high-kVp sinogram can be added to the contrast-augmented single-energy sinogram to generate the contrast-augmented sparse high-kVp sinogram. The use of the residual preserves a difference between the single-energy and the sparse-view sinograms prior to contrast augmentation. The contrast-augmented sparse high-kVp sinogram can then be interpolated to generate the interpolated high-kVp sinogram, which is also contrast-augmented consistent with the sparse sinogram. The sparse and interpolated sinograms can then be input along with the edge map (in sinogram form) to the model for training. The model can be trained to predict a high-kVp sinogram using the sparse and interpolated high-kVp sinograms and edge map as conditional images. In one embodiment, the model can be trained to minimize a loss function describing an error between a predicted sinogram and a target sinogram as described herein. The target sinogram (training label) can be the original single-energy sinogram.

FIG. 6B is an illustration of a network training workflow using residuals to augment sinograms according to one embodiment of the present disclosure. A residual low-kVp sinogram can be a difference between the sparse low-kVp sinogram and the single-energy full-view sinogram. Contrast augmentation can be applied to the single-energy (full-view) sinogram. The residual low-kVp sinogram can be added to the contrast-augmented single-energy sinogram to generate the contrast-augmented sparse low-kVp sinogram. The contrast-augmented sparse low-kVp sinogram can then be interpolated to generate the interpolated low-kVp sinogram, which is also contrast-augmented consistent with the sparse sinogram. The sparse and interpolated low-kVp sinograms can then be input along with the edge map (in sinogram form) to the model for training. The model can be trained to predict a low-kVp sinogram using the sparse and interpolated low-kVp sinograms and edge map as conditional images. In one embodiment, the model can be trained to minimize a loss function describing an error between a predicted sinogram and a target sinogram as described herein. The target sinogram (training label) can be the original single-energy FVCT.

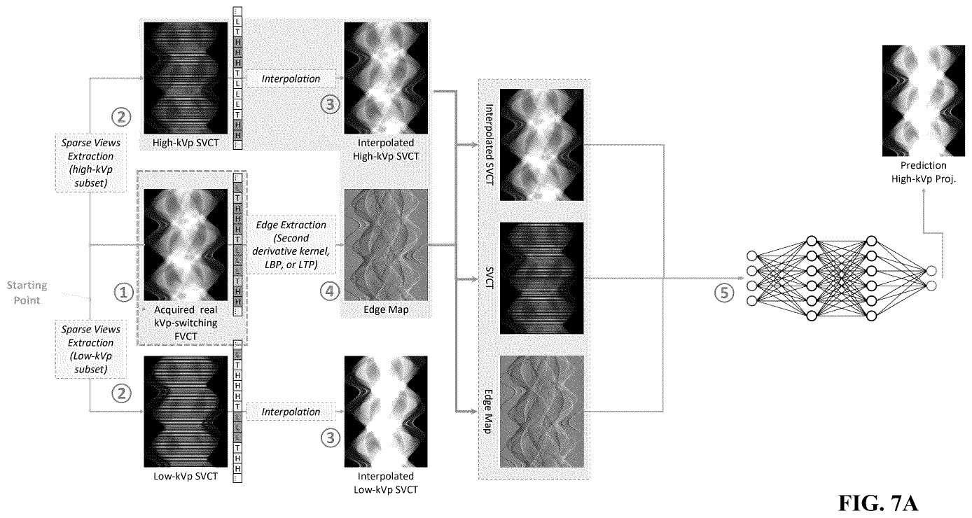

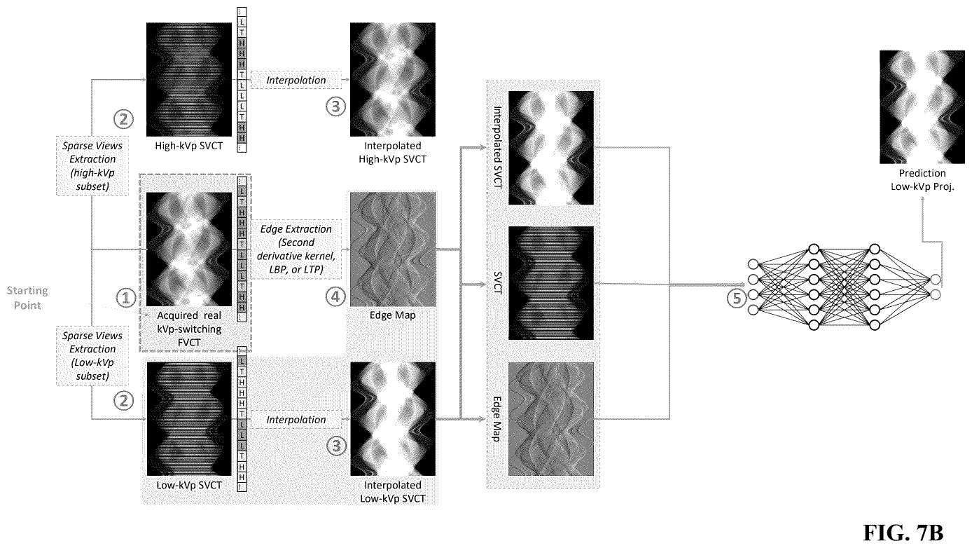

FIG. 7A is an illustration of deployment of a trained network in the sinogram domain to generate a predicted high-kVp sinogram from a dual-kVp sinogram according to one embodiment. The trained network can generate predicted low-kVp and high-kVp sinograms from an acquired full-view sinogram (FVCT) using kVp switching.

Initially, the acquired FVCT can be pre-processed before being input to the trained network. In one embodiment, the pre-processing can include separating (extracting) the high-kVp sinogram data and the low-kVp sinogram data. The resulting high-kVp and low-kVp sinograms are sparse-view sinograms. In one embodiment, the high- and low-kVp sinogram data can be extracted based on a pattern of high (H), low (L), and transition (T) pixels according to the dual-energy acquisition protocol as illustrated in FIG. 7A. The high-kVp sinogram and the low-kVp sinogram can be interpolated to fill in the missing data points after extraction, generating an interpolated high-kVp sinogram and an interpolated low-kVp sinogram. The pre-processing can include generating an edge map based on the acquired dual-energy sinogram. In one embodiment, the method for generating the edge map (e.g. via second derivative kernel, local binary pattern, local ternary pattern, etc.) can match the method used during network training.

In one embodiment, the trained network can be used to predict a high-kVp sinogram as illustrated in FIG. 7A. The conditional inputs to the trained network can be the sparse high-kVp sinogram, the interpolated high-kVp sinogram, and the edge map. The predicted high-kVp sinogram can be of higher quality than the input sinograms.

FIG. 7B is an illustration of deployment of the trained network in the sinogram domain to generate a predicted low-kVp sinogram from a dual-kVp sinogram according to one embodiment. The sparse low-kVp sinogram, the interpolated low-kVp sinogram, and the edge map can be conditional inputs to the trained network. The trained network can predict a low-kVp sinogram based on the input sinograms. The predicted low-kVp sinogram can be of higher quality than the input sinograms. In this manner, the trained model can be used to generate (predict) both high- and low-kVp sinograms based on a single dual-energy sinogram. The trained model can be used for accurate prediction even when the training data does not include separate high- and low-kVp sinogram data.

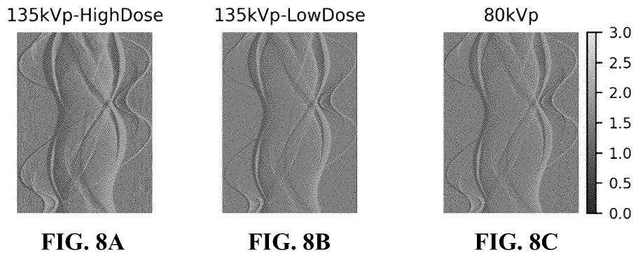

FIGS. 8A-8C are examples of texture maps that are extracted from an abdominal phantom scan using the local binary pattern described herein. FIG. 8A is a texture map that is extracted from an actual high-dose scan at 135 kVp. FIG. 8B is a texture map that is extracted from a simulated low-dose scan. The simulated low-dose scan can be derived from the high-dose 135 kVp scan as described herein. FIG. 8C is a texture map that is extracted from an actual low-dose scan at 80 kVp. The texture map for the simulated low dose is similar to the texture map for the actual low dose of 80 kVp, indicating that the simulation of a low-dose scan is sufficient for training and deploying the model.

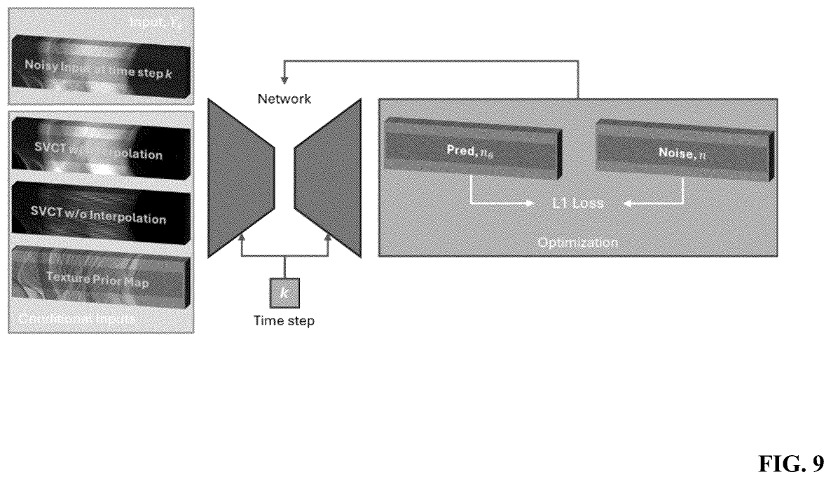

FIG. 9 is a schematic of a network (e.g. a DDPM) according to one embodiment of the present disclosure. In one embodiment, the network architecture can be as described in N. Yuan, J. Zhou, and J. Qi, “Sparse-view CT Spatial Resolution Enhancement via Denoising Diffusion Probabilistic Models,” in Proceedings of the 17th International Meeting on Fully 3D Image Reconstruction in Radiology and Nuclear Medicine, 2023, pp. 470-47, which is incorporated herein by reference in its entirety. In one embodiment, the DDPM can be a 3D patch-based model to handle sinogram-domain data. The input to the DDPM can be a noisy input image, and the conditional inputs can be the sparse-view sinogram, the interpolated sinogram, and a texture map. At each time step k, the DDPM can predict a further denoised image based on the conditional inputs. In one embodiment, the DDPM training can include using 3D sinogram patches of different sizes from 128 detector channels, 128 angular positions, and 32 slices that were randomly extracted from a full sinogram. In one embodiment, the number of root features can be 64 and the total number of timesteps can be 1000.

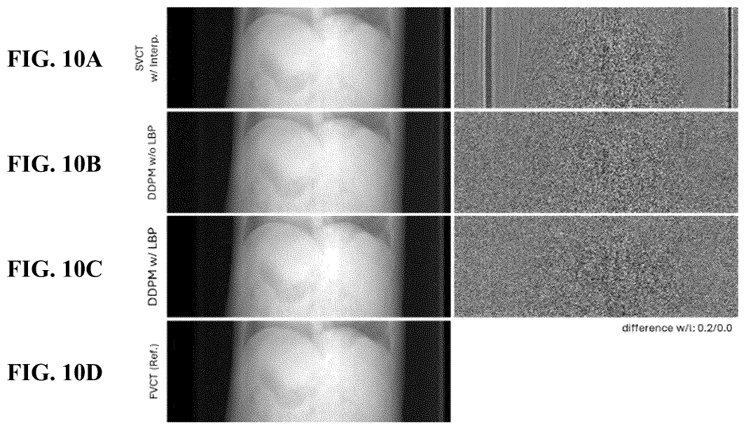

FIGS. 10A-10D are examples of acquired and DDPM-predicted sinograms according to one embodiment of the present disclosure. FIG. 10A is an interpolated sinogram from a single-energy kVp scan. FIG. 10B is a DDPM-predicted sinogram based on the interpolated sinogram without the use of an edge map as a conditional image. FIG. 10C is a DDPM-predicted sinogram based on the interpolated sinogram with the use of an edge map as a conditional image. FIG. 10D is a full-view sinogram used as a reference image.

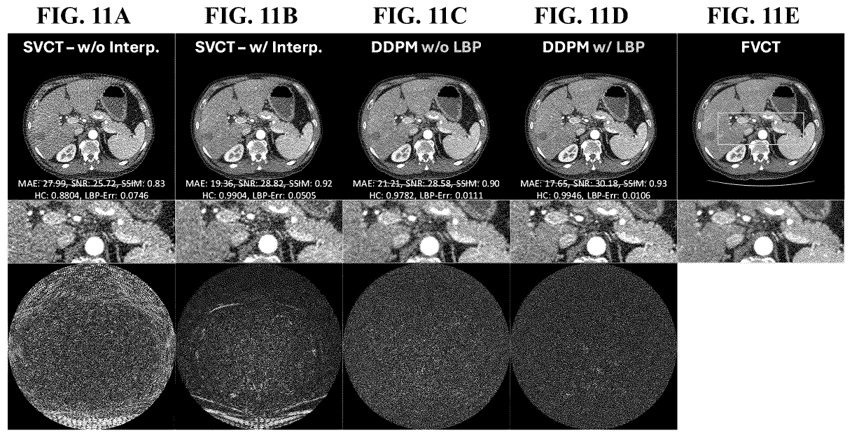

FIG. 11A is an example of a CT image (a representative image slice) that is reconstructed from a simulated sparse-view single-energy kVp scan without interpolation. High-kVp sparse-view data can be simulated from a full-view scan by setting pixel values of projection at the transition and opposite (low-kVp) energy positions to zero. FIG. 11B is an example of a CT image that is reconstructed with interpolation. FIG. 11C is an example of a DDPM-predicted CT image without a local binary pattern texture map. FIG. 11D is an example of a DDPM-predicted CT image with a local binary pattern texture map. FIG. 11E is an example of a full-view reconstructed image used as a reference image. FIGS. 11A-11D also include image-domain metrics describing the comparison between each image and the reference image of FIG. 11E. The metrics can include mean absolute error (MAE), signal-to-noise ratio (SNR), structural similarity index (SSIM), histogram correlation (HC), and LBP-based texture error (LBP-Err). The DDPM-predicted images have significantly improved image quality over the reconstructed images, with reductions in noise and streaky artifacts leading to enhanced MAE, SNR, and SSIM values. Additionally, the DDPM prediction sharpened anatomical boundaries and preserved textures, as shown in the enlarged regions of each of FIG. 11A-11D. The DDPM model that used an LBP texture map further improved texture restoration and better preserved fine structures in certain regions.

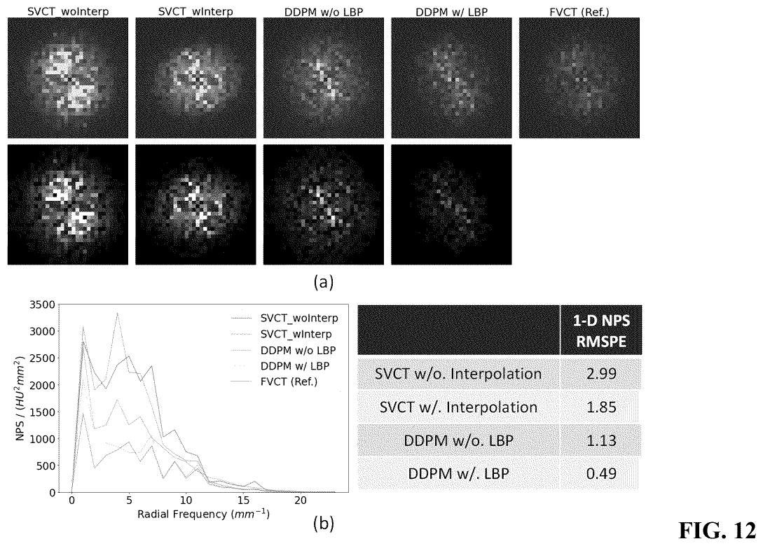

FIG. 12 is an example of a noise power spectrum (NPS) computed from a uniform liver region. Two-dimensional and one-dimensional NPS analyses indicate that LBP texture maps effectively guide the network in restoring accurate textures and preserving fine details, closely matching the FVCT reference image.

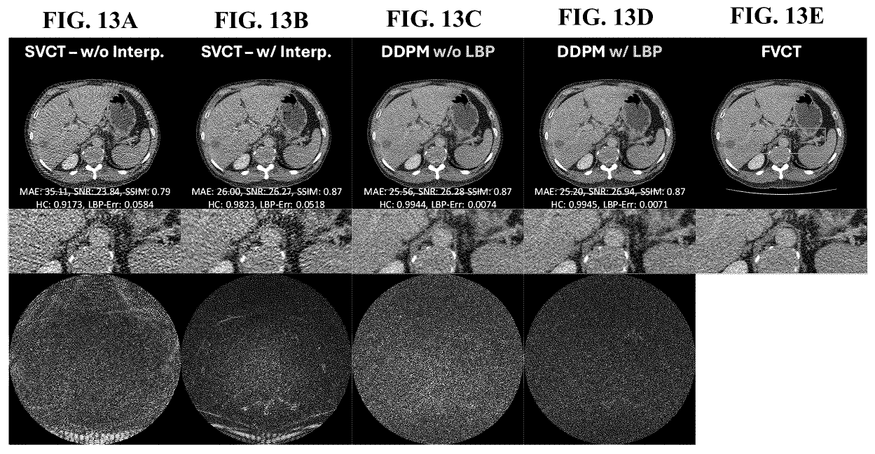

FIG. 13A is an example of a high-kVp (135 kVp) CT image (a representative image slice) that is reconstructed from an acquired dual-energy (135 kVp and 80 kVp) scan without interpolation. FIG. 13B is an example of a high-kVp CT image that is reconstructed from the acquired dual-energy scan with interpolation. FIG. 13C is an example of a DDPM-predicted high-kVp CT image based on the dual-energy scan without an LBP texture map. FIG. 13D is an example of a DDPM-predicted high-kVp CT image based on the dual-energy scan with an LBP texture map. FIG. 13E is an example of a full-view reconstructed image used as a reference image.

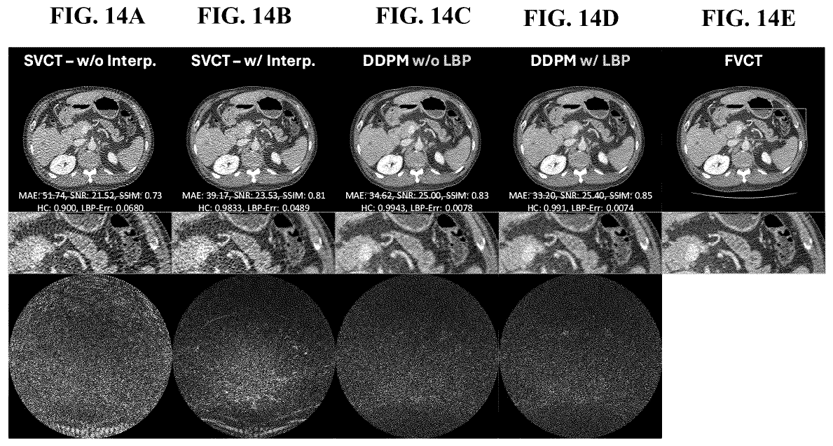

FIG. 14A is an example of a low-kVp (80 kVp) CT image (a representative image slice) that is reconstructed from the acquired dual-energy scan without interpolation. FIG. 14B is an example of a low-kVp CT image that is reconstructed from the acquired dual-energy scan with interpolation. FIG. 14C is an example of a DDPM-predicted low-kVp CT image based on the dual-energy scan without an LBP texture map. FIG. 14D is an example of a DDPM-predicted low-kVp CT image based on the dual-energy scan with an LBP texture map. FIG. 14E is an example of a full-view reconstructed image used as a reference image.

The same DDPM, which is trained using single-energy data with augmentation, can be used to predict both high- and low-kVp images as demonstrated by FIG. 13D and FIG. 14D. The training data can be, for example, single-energy CT scans acquired at 120 kVp that are used to simulate high-kVp scan data for training. In one embodiment, the training only uses high-kVp scan data (simulated or actual) and does not use low-kVp scan data. The DDPM can be generalized across different energy levels through the training. The DDPM-predicted images can have lower errors when compared with the reference image than the images that are reconstructed without a DDPM.

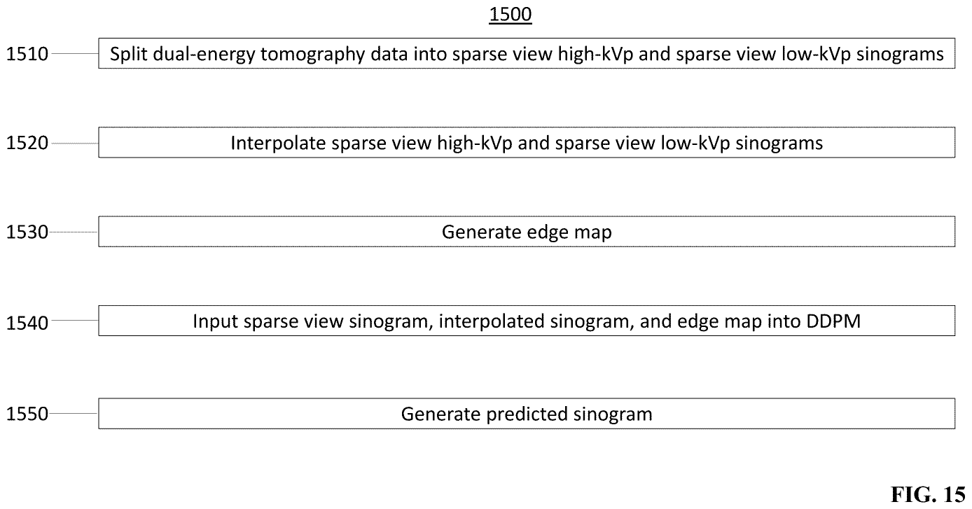

FIG. 15 is a method 1500 of predicting a single-energy sinogram from dual-energy tomography data using a DDPM according to one embodiment of the present disclosure. The method can be applied to predicting a high-kVp sinogram or a low-kVp sinogram. The method can also be applied to predict a reconstructed using a DDPM by generating reconstructed images from the sinogram inputs and training data. In step 1510, a dual-energy CT sinogram can be split into a sparse view high-kVp sinogram and a sparse-view low-kVp sinogram. In step 1520, each of the sparse view high-kVp sinogram and low-kVp sinogram can be interpolated to generate an interpolated high-kVp sinogram and interpolated low-kVp sinogram. In step 1530, an edge map can be generated from the mixed view sinogram. In step 1540, a sparse view sinogram (one of the sparse view low-kVp or high-kVp sinograms), a corresponding interpolated sinogram (one of the interpolated low-kVp or high-kVp sinograms), and the edge map can be input as conditional inputs to a previously trained DDPM as described in the present disclosure. In step 1550, the DDPM can output a predicted sinogram corresponding to the same energy level as the inputs based on the inputs.

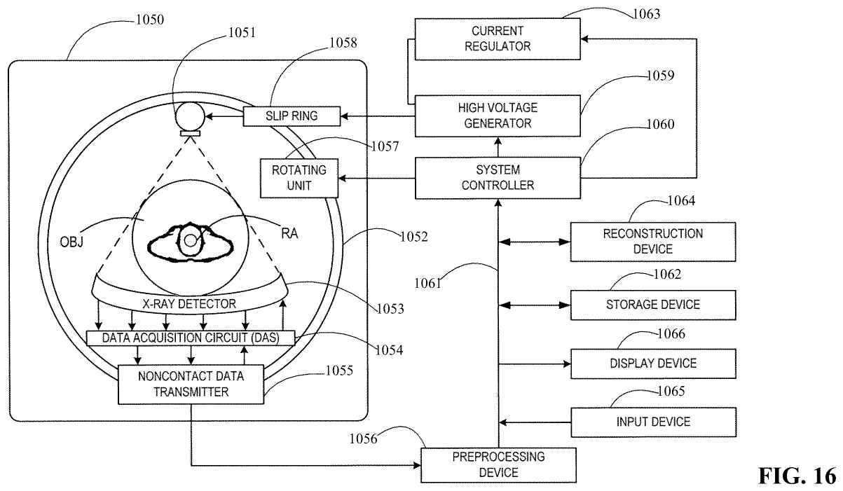

FIG. 16 is a schematic block diagram of a CT apparatus or scanner, according to one embodiment of the present disclosure. As shown in FIG. 16, a radiography gantry 1050 is illustrated from a side view and further includes an X-ray tube 1051, an annular frame 1052, and a multi-row or two-dimensional-array-type X-ray detector 1053. The X-ray tube 1051 and X-ray detector 1053 are diametrically mounted across an object OBJ on the annular frame 1052, which is rotatably supported around a rotation axis RA. A rotating unit 1057 rotates the annular frame 1052 at a high speed, such as 0.275 sec/rotation, while the object OBJ is being moved along the axis RA into or out of the illustrated page.

An embodiment of an X-ray CT apparatus according to the present disclosure will be described below with reference to the views of the accompanying drawing. Note that X-ray CT apparatuses include various types of apparatuses, e.g., a rotate/rotate-type apparatus in which an X-ray tube and X-ray detector rotate together around an object to be examined, and a stationary/rotate-type apparatus in which many detection elements are arrayed in the form of a ring or plane, and only an X-ray tube rotates around an object to be examined. The present disclosure can be applied to either type. In this case, the rotate/rotate-type, which is currently the mainstream, will be exemplified.

The multi-slice X-ray CT apparatus further includes a high voltage generator 1059 that generates a tube voltage applied to the X-ray tube 1051 through a slip ring 1058 so that the X-ray tube 1051 generates X-rays. The X-rays are emitted towards the object OBJ, whose cross-sectional area is represented by a circle. For example, the X-ray tube 1051 having an average X-ray energy during a first scan that is less than an average X-ray energy during a second scan. Thus, two or more scans can be obtained corresponding to different X-ray energies. The X-ray detector 1053 is located at an opposite side from the X-ray tube 1051 across the object OBJ for detecting the emitted X-rays that have transmitted through the object OBJ. The X-ray detector 1053 further includes individual detector elements or units.

The CT apparatus further includes other devices for processing the detected signals from the X-ray detector 1053. A data acquisition circuit or a Data Acquisition System (DAS) 1054 converts a signal output from the X-ray detector 1053 for each channel into a voltage signal, amplifies the signal, and further converts the signal into a digital signal. The X-ray detector 1053 and the DAS 1054 are configured to handle a predetermined total number of projections per rotation (TPPR).

The above-described data is sent to a preprocessing device 1356, which is housed in a console outside the radiography gantry 1050 through a non-contact data transmitter 1355. The preprocessing device 1056 performs certain corrections, such as sensitivity correction, on the raw data. A memory 1062 stores the resultant data, which is also called projection data at a stage immediately before reconstruction processing. The memory 1062 is connected to a system controller 1060 through a data/control bus 1061, together with a reconstruction device 1064, input device 1065, and display 1066. The system controller 1060 controls a current regulator 1063 that limits the current to a level sufficient for driving the CT system.

The detectors are rotated and/or fixed with respect to the patient among various generations of the CT scanner systems. In one implementation, the above-described CT system can be an example of a combined third-generation geometry and fourth-generation geometry system. In the third-generation system, the X-ray tube 1051 and the X-ray detector 1053 are diametrically mounted on the annular frame 1052 and are rotated around the object OBJ as the annular frame 1052 is rotated about the rotation axis RA. In the fourth-generation geometry system, the detectors are fixedly placed around the patient and an X-ray tube rotates around the patient. In an alternative embodiment, the radiography gantry 1050 has multiple detectors arranged on the annular frame 1052, which is supported by a C-arm and a stand.

The memory 1062 can store the measurement value representative of the irradiance of the X-rays at the X-ray detector unit 1053. Further, the memory 1062 can store a dedicated program for executing the CT image reconstruction, material decomposition, and motion estimation and motion compensation methods including the methods described herein.

The reconstruction device 1064 can execute the above-referenced methods, described herein. Further, reconstruction device 1064 can execute pre-reconstruction processing image processing such as volume rendering processing and image difference processing as needed.

The pre-reconstruction processing of the projection data performed by the preprocessing device 1056 can include correcting for detector calibrations, detector nonlinearities, and polar effects, for example.

Post-reconstruction processing performed by the reconstruction device 1064 can include filtering and smoothing the image, volume rendering processing, and image difference processing, as needed. The image reconstruction process can be performed using filtered back projection, iterative image reconstruction methods, or stochastic image reconstruction methods. The reconstruction device 1064 can use the memory to store, e.g., projection data, reconstructed images, calibration data and parameters, and computer programs.

The reconstruction device 1064 can include a CPU or GPU (processing circuitry) that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VDHL, Verilog, or any other hardware description language and the code may be stored in an electronic memory directly within the FPGA or CPLD, or as a separate electronic memory. Further, the memory 1062 can be non-volatile, such as ROM, EPROM, EEPROM or FLASH memory. The memory 1062 can also be volatile, such as static or dynamic RAM, and a processor, such as a microcontroller or microprocessor, can be provided to manage the electronic memory as well as the interaction between the FPGA or CPLD and the memory.

Alternatively, the CPU in the reconstruction device 1064 can execute a computer program including a set of computer-readable instructions that perform the functions described herein, the program being stored in any of the above-described non-transitory electronic memories and/or a hard disc drive, CD, DVD, FLASH drive or any other known storage media. Further, the computer-readable instructions may be provided as a utility application, background daemon, or component of an operating system, or combination thereof, executing in conjunction with a processor, such as a Xeon processor from Intel of America or an Opteron processor from AMD of America and an operating system, such as Microsoft 10, UNIX, Solaris, LINUX, Apple, MAC-OS and other operating systems known to those skilled in the art. Further, CPU can be implemented as multiple processors cooperatively working in parallel to perform the instructions.

In one implementation, the reconstructed images can be displayed on a display 1366. The display 1066 can be an LCD display, CRT display, plasma display, OLED, LED or any other display known in the art.

The memory 1062 can be a hard disk drive, CD-ROM drive, DVD drive, FLASH drive, RAM, ROM or any other electronic storage known in the art.

Numerous modifications and variations of the embodiments presented herein are possible in light of the above teachings. It is therefore to be understood that within the scope of the claims, the application may be practiced otherwise than as specifically described herein. The inventions are not limited to the examples that have just been described; it is in particular possible to combine features of the illustrated examples with one another in variants that have not been illustrated.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

Obviously, numerous modifications and variations of the present invention are possible in light of the above teachings. It is therefore to be understood that within the scope of the appended claims, the invention may be practiced otherwise than as specifically described herein.

1. A method for reconstructing computed tomography (CT) images, comprising:
receiving dual-energy tomography data acquired by imaging an object using a CT apparatus, the dual-energy tomography data including a first set of tomography data at a first energy level and a second set of tomography data at a second energy level, the second energy level being greater than the first energy level;
generating, based on the dual-energy tomography data, a first sparse view projection of the first set of tomography data at the first energy level and a second sparse view projection of the second set of tomography data at the second energy level;
generating, based on the dual-energy tomography data, a texture map; and
generating a predicted image at the first energy level by applying the first sparse view projection and the generated texture map to a trained machine learning model, wherein
the trained machine learning model was previously trained to generate an image using a set of training data comprising a training sparse view projection of single-energy tomography data and a training texture map generated from the single-energy tomography data.

2. The method of claim 1, wherein the generating the predicted image further comprises applying the first sparse view projection and the generated texture map to a trained denoising diffusion probabilistic model.

3. The method of claim 1, further comprising interpolating the first sparse view projection to generate a first interpolated sparse view projection, wherein the generating the predicted image further comprises applying the first interpolated sparse view projection to the trained machine learning model.

4. The method of claim 1, further comprising generating a second predicted image at the second energy level by applying the second sparse view projection and the generated texture map to the trained machine learning model.

5. The method of claim 1, wherein the trained machine learning model was previously trained using the set of training data further comprising a simulated single-energy tomography data based on the single-energy tomography data at a different energy level from the single-energy tomography data.

6. The method of claim 1, wherein the trained machine learning model was previously trained using the set of training data further comprising an interpolated projection of the single-energy tomography data.

7. The method of claim 1, wherein the generating the texture map further comprises assigning a binary number to each pixel in the dual-energy tomography data based on a comparison between the pixel, a neighboring left pixel, and a neighboring right pixel.

8. A computed tomography (CT) apparatus, comprising:
processing circuitry configured to
receive dual-energy tomography data acquired by imaging an object using a CT apparatus, the dual-energy tomography data including a first set of tomography data at a first energy level and a second set of tomography data at a second energy level, the second energy level being greater than the first energy level;
generate, based on the dual-energy tomography data, a first sparse view projection of the first set of tomography data at the first energy level and a second sparse view projection of the second set of tomography data at the second energy level;
generate, based on the dual-energy tomography data, a texture map; and
generate a predicted image at the first energy level by applying the first sparse view projection and the generated texture map to a trained machine learning model, wherein
the trained machine learning model was previously trained to generate an image using a set of training data comprising a training sparse view projection of single-energy tomography data and a training texture map generated from the single-energy tomography data.

9. The apparatus of claim 8, wherein the processing circuitry is further configured to generate the predicted image by applying the first sparse view projection and the generated texture map to a trained denoising diffusion probabilistic model.

10. The apparatus of claim 9, wherein the processing circuitry is further configured to apply the first sparse view projection and the generated texture map to the trained denoising diffusion probabilistic model as conditional inputs.

11. The apparatus of claim 8, wherein the processing circuitry is further configured to interpolate the first sparse view projection to generate a first interpolated sparse view projection and apply the first interpolated sparse view projection to the trained machine learning model to generate the predicted image.

12. The apparatus of claim 8, wherein the processing circuitry is further configured to generate a second predicted image at the second energy level by applying the second sparse view projection and the generated texture map to the trained machine learning model.

13. The apparatus of claim 8, wherein the trained machine learning model was previously trained using the set of training data further comprising a simulated single-energy tomography data based on the single-energy tomography data at a different energy level from the single-energy tomography data.

14. The apparatus of claim 8, wherein the trained machine learning model was previously trained using the set of training data further comprising an interpolated projection of the single-energy tomography data.

15. The apparatus of claim 8, wherein the processing circuitry is further configured to generate the texture map by assigning a binary number to each pixel in the dual-energy tomography data based on a comparison between the pixel, a neighboring left pixel, and a neighboring right pixel.

16. A non-transitory computer-readable storage medium for storing computer readable instructions that, when executed by a computer, cause the computer to perform a method, the method comprising:
receiving dual-energy tomography data acquired by imaging an object using a CT apparatus, the dual-energy tomography data including a first set of tomography data at a first energy level and a second set of tomography data at a second energy level, the second energy level being greater than the first energy level;
generating, based on the dual-energy tomography data, a first sparse view projection of the first set of tomography data at the first energy level and a second sparse view projection of the second set of tomography data at the second energy level;
generating, based on the dual-energy tomography data, a texture map; and
generating a predicted image at the first energy level by applying the first sparse view projection and the generated texture map to a trained machine learning model, wherein
the trained machine learning model was previously trained to generate an image using a set of training data comprising a training sparse view projection of single-energy tomography data and a training texture map generated from the single-energy tomography data.

17. The non-transitory computer-readable storage medium of claim 16, wherein the generating the predicted image further comprises applying the first sparse view projection and the generated texture map to a trained denoising diffusion probabilistic model.

18. The non-transitory computer-readable storage medium of claim 17, wherein the generating the predicted image further comprises applying the first sparse view projection and the generated texture map to the trained denoising diffusion probabilistic model as conditional inputs.

19. The non-transitory computer-readable storage medium of claim 16, wherein the interpolating the first sparse view projection to generate a first interpolated sparse view projection, wherein the generating the predicted image further comprises applying the first interpolated sparse view projection to the trained machine learning model.
